(19) United States
(12) Patent Application Publication
(10) Pub. No.: US 2005/0017513 A1
(43) Pub. Date: Jan. 27, 2005

(54) Hydro-power generating system

(76) Inventor: Peter Fox Sipp, Burnsville, NC (US)

Correspondence Address: DAVID M. CARTER;CARTER SCHNEDLER & MONTEITH, P.A., 56 CENTRAL AVENUE, SUITE 101, P.O. BOX 2985, ASHVILLE, NC, 28802, US

(21) Appl. No.: 10/627,129

(22) Filed: Jul. 24, 2003

(51) Int. Cl. H02P 9/04; F03B 13/00

(52) U.S. Cl. 290/54

(57) ABSTRACT

There is provided a hydro-power generating system including a wheel assembly having at least one rotatable wheel. The rotatable wheel is adapted to interface with moving water. The rotatable wheel rotates when contacting moving water, thereby generating power. An elongated rigid structure is provided with at least a portion thereof located above the rotatable wheel. The elongated rigid structure is secured so that the moving water will not cause the elongated rigid structure to move substantially. The wheel assembly includes at least one floatation member wherein the rotatable wheel will only be partially submerged in the moving water. The wheel assembly is connected to the elongated rigid structure so that the wheel assembly is held in place in the moving water. The wheel assembly is slidably connected to the elongated rigid structure so that the rotatable wheel may move vertically as the level of the moving water changes. A funnel and a screen are situated adjacent to and upstream of the wheel assembly.

This invention relates to systems for generating power, such as electrical power. More specifically, it relates to hydro-power generating systems which do not rely on dams.

### BACKGROUND OF THE INVENTION

Some of the greatest challenges facing humanity today stem from the by products of energy generation and utilization. Carbon dioxide, sulfur, radioactive waste and other wastes and emissions challenge both human and environmental health and economic profitability of fossil and nuclear energy, making sustainable energy generation not only a preferred “alternative,” but also, a necessity. While wind powered generation, worldwide, is the fastest growing form of new generating capacity, it, and solar, are intermittent generating sources. Hydroelectric generation has long stood as a reliable, constant source of renewable power generation that produces no waste or emissions.

The sun's energy and Earth's gravity provide the sustaining cycle for freshwater hydro-mechanical and hydroelectric generating systems. The sun shines on Earth's oceans, causing evaporation and distillation of saltwater. Clouds travel and freshwater rains down on our lands. Gravity pulls this water back to the oceans where the whole cycle is repeated daily. The only “waste” is when this power potential is not utilized.

While in the past century large dams were erected to maximize the kinetic potential of freshwater, these have proved to have consequences that are not always beneficial, including loss of traditional lands, loss and disruption of habitat, both land and aquatic, and even reports of slowing of the axial rotation of Earth, due to the artificial concentration of the great mass in reservoirs. In order to expand the existing hydro-generating capacity at a level that will meaningfully prevent and displace further generation of CO₂, radioactive waste and other problematic by-products of fossil/nuclear power sources, it is important to develop systems that will not cause additional “collateral damage.” The following desirable attributes are required for such a system:
First: Power generation is from the ambient flow of water without a dam or other diversion.
Second: Potential for large-scale installation to capture the kinetic energy of large rivers, and tides.
Third: Sufficient structural integrity to withstand the forces of moving water and also the forces originating from the capture of kinetic energy, such as torque.
Fourth: Flexibility so that the generating unit can be safeguarded in the event of flood, seasonal usage and for repair.
Fifth: Ability to utilize the energy of relatively shallow waterways with little “head.”
Sixth: Designed to be viable given access to only one side of a waterway, since often rivers and streams are the geographic boundary of ownership and/or political territories, while in the same design capturing the greatest kinetic potential in a given stretch of water.
Seventh: Simplicity and durability for power generation for not only decades, but centuries where appropriate.
Eighth: No material is discharged from the system on a routine basis, and any that might be released and be born by water or persist in soil, is non-polluting food-grade material.
Ninth: Completely removable in the event that the site is no longer suitable for power generation; removal generates no hazardous waste, and no contamination remains on the site.

A system that meets all these requirements is also compatible with rehabilitation of previously disturbed (brown field) frontage of waterways.

### SUMMARY OF THE INVENTION

In accordance with one form of this invention, there is provided a hydro-power generating system. A wheel assembly is provided which includes at least one rotatable wheel. The rotatable wheel is adapted to interface with moving water. The rotatable wheel rotates when contacting moving water thereby generating power. An elongated rigid structure is provided. At least a portion of the elongated rigid structure is located above the rotatable wheel. The rigid structure is secured so that the moving water will not cause the rigid structure to move substantially. The wheel assembly includes at least one floatation member wherein the rotatable wheel will only be partially submerged in the moving water. The wheel assembly is connected to the rigid structure so that the wheel assembly is held in place in the moving water. Preferably, the wheel assembly is slidably connected to the rigid structure so that the rotatable wheel may move vertically as the level of the moving water changes.

It is also preferred that the floatation member include a pair of pontoons connected on opposite sides of the rotatable wheel. Also preferably, at least one rod extends upwardly from each of the pontoons and that first and second hollow sleeves extend downwardly from the rigid structure. Also preferably, the rod from the first pontoon is slidably received in the first sleeve and the rod of the second pontoon is slidably received in the second sleeve.

It is also preferred that the rigid structure is raisable and rotatable so that the wheel assembly may be removed from the moving water. In addition, it is preferred that a screen is provided and adapted to be located in close proximity to, but upstream from, the wheel assembly. The screen permits water to readily pass there through and reduces the likelihood that debris will interfere with the rotatable wheel.

It is also preferred that a funnel assembly be placed adjacent to the wheel assembly. The funnel assembly is for increasing the speed of the moving water as the moving water contacts the rotatable drum.

In accordance with another form of the invention, there is provided a hydro-power generating system, including a wheel assembly having at least one rotatable wheel. The rotatable wheel is adapted to interface with moving water. The rotatable wheel rotates when contacted by moving water, thus generating power. A funnel assembly is provided. The funnel assembly has a wide open end and a narrow open end. The narrow open end of the funnel assembly is located adjacent to the wheel assembly. The funnel assembly will increase the speed of the moving water as the moving water contacts the rotatable wheel.

In accordance with another form of the invention, In accordance with another form of the invention, there is provided a hydro-power generating system, including a wheel assembly having at least one rotatable wheel. The rotatable wheel is adapted to interface with moving water. The rotatable wheel rotates when contacted by moving water, thus generating power. A screen is provided. The screen is located in close proximity to and upstream from the wheel assembly. The screen will permit water to readily pass there through while reducing the likelihood that debris will interfere with the rotatable wheel.

### BRIEF DESCRIPTION OF THE DRAWINGS

The subject matter regarded as the invention is set forth in the appended claims. The invention itself, however, together with further objects and advantages thereof may be better understood in reference to the accompanying drawings in which:

FIG. 1a is a generalized perspective view showing one embodiment of the present invention.

FIG. 1b is a more detailed perspective view of the embodiment of FIG. 1a.

FIG. 2 is a top view of the embodiment of FIG. 1b.

FIG. 3a is a partial perspective view showing certain details of FIG. 1b with the jib crane raised and fully rotated to shore.

FIG. 3b is a side elevational view of a portion of FIG. 1b with the drawbridge shown in the raised position.

FIG. 4 is a top view of a portion of the apparatus of FIG. 1b showing the position of the rollers.

FIG. 5 is a side view of a portion of the apparatus of FIG. 1b with portions cut away.

FIG. 6a is top view showing a portion of the apparatus of FIG. 1b showing the rollers in detail.

FIG. 6b is a side elevational view of the apparatus of FIG. 6a.

FIG. 7 is a side view of a portion of the apparatus of FIG. 1b.

FIG. 8 is a side view of a portion of the apparatus of FIG. 1b.

FIG. 9a is a side view of a portion of the apparatus of FIG. 1b.

FIG. 9b is an end view of the apparatus of FIG. 9a.

FIG. 10a is a side elevational view of a portion of the apparatus of FIG. 1b showing the wheel in the down position.

FIG. 10b shows the apparatus of FIG. 10a with the wheel in a fully raised position and the screen remaining down.

FIG. 10c shows the apparatus of FIG. 10a with the wheel in the fully raised position with the screen also fully raised.

FIG. 11a is a side elevational view showing the three wheels which form the wheel assembly.

FIG. 11b is a front view of the wheel assembly of FIG. 1b.

FIG. 12a is an end view detailed showing of the speed increaser of FIG. 1b.

FIG. 12b is a side elevational view of the apparatus of FIG. 12a.

FIG. 13a is a general perspective view showing another embodiment of the subject invention.

FIG. 13b is top view of the apparatus of FIG. 13a.

FIG. 13c is a generalized top view showing a portion of the apparatus of FIG. 1a used in a tidal installation.

### DESCRIPTION OF THE PREFERRED EMBODIMENTS

### Overview

The invention is a unique array of classical elements which, when combined, generate electricity or direct mechanical power from the moving water without a dam or other substantial diversion of the water. The system enables the generating station to be rapidly removed in the event of flood or other seasonal changes and for services to be performed.

The system may include: an anchor with service hull, a jib crane, a water wheel floating on pontoons, a drawbridge, a screen, a speed increaser, and one or more generators, or, in the case of mechanical power generation, a pump and one or more shafts. This overview will focus on electrical generation.

Electricity is generated by the rotation of a large diameter, wide-bladed wheel, or a plurality of wheels, pushed at the bottom by the flow of water, with the axel supported by pontoons. The slow turning of the wheel is translated into electrical power by the use of a speed increaser and generator(s) {or alternator(s)} which may be located on one of the pontoons. This energy may then be fed into electrical lines or storage batteries. The system is stabilized and safeguarded by a drawbridge located upstream of the wheel. The drawbridge supports a protective screen.

The anchor provides robust footing on one side of the waterway. The base for both the crane and drawbridge is attached to the anchor.

The jib crane both positions the wheel while it is at work in the water and is also the means to move the wheel out of the path of danger (such as flood), or move it to land for repair and maintenance. The end of the crane is fitted with a structure designed to allow the wheel to float up on pontoons with rising water, and also with stops to keep the wheel from falling below a minimum level, thus preventing the wheel from scraping the bed of the waterway. At low water, the wheel and its pontoons are suspended from the crane. A catwalk and guided ladder allow access to the wheel, speed increaser and generator.

The drum or wheel is a long, wide cylinder with multiple cup-shaped blades. The wheel may be simple, or divided into sections, such that the blades are off-set to facilitate smooth rotation. The edge of the wheel closest to the anchor is fitted with a gear around the circumference. This gear may be traditional, pegged, or any other device, in every case it interlocks to a very small gear or wheel, which is then belted to the speed increaser on the pontoon adjacent to the wheel gear.

The speed increaser is a series of belts and pulleys on shafts using the classic alternation of small and large diameter rotating pulleys to step up the revolutions per minute from the slow rotation of the wheel in the water up to the rpm required for power generation. In large scale installations a gearbox might be substituted for the speed increaser and perform the same function.

The generator or generators may be situated on the pontoon with the speed increaser and an electric line runs from the generator to storage batteries or through an inverter and then to the electric power grid.

Removing the wheel, pontoons, speed increaser and generator from the waterway is accomplished by first raising the wheel pontoons assembly to the maximum “up” position via winch and pulleys or other mechanisms. The protective screen is also released from the drawbridge and ready to be carried by the crane with the wheel. The crane is then released from the drawbridge and rotated approximately 180 degrees in the downstream direction to deliver the wheel assembly and screen to a safe position above the waterline. In some cases a “wheel rack” may be installed above the water line to hold the wheel assembly, temporarily freeing the crane for other work.

The drawbridge function is to provide stability to the crane and wheel, and to support the protective screen that prevents objects from crashing into the blades of the wheel. Anchored next to and up stream of the jib-crane, the drawbridge is cross-linked to the crane at multiple points when both structures are deployed in the “at work” position. These links are released when the wheel is to be removed from the water.

The drawbridge supports the protective screen that stops any debris or objects from colliding with the wheel. When the wheel is safely raised out of the water, and the screen is clear and unobstructed, it is transferred to supports on the crane and removed from the work area with the wheel. If large objects have collected on the screen, it may be necessary to eject it from the bridge once the wheel is up and out of the way. The screen will be tethered to the anchor, so it can be recovered later.

Once the wheel and the screen have been removed, or the screen ejected, the drawbridge may be lifted, by means of winch and pulleys, or other mechanical devices. Lifting the bridge removes it from the path of objects that may be in floodwaters.

While the wheel assembly is out of the water, maintenance including greasing the bearings on the speed increaser and wheel can be accomplished using food grade grease.

To return to power generation, the system is deployed in the following way: First the drawbridge is lowered into its cradle and rests in the horizontal position. Second, the crane holding wheel/pontoon assembly (wheel, pontoons, speed increaser and generator) and screen, is swung from its safe location above the waterline back to a position parallel to the drawbridge. The cross links between the bridge and the crane are linked and the stabilizing pin is then inserted from the base of the crane into the deck of the service hull on the anchor, securing the crane parallel to the bridge. The robust bridge stabilizes the crane and the screen from being pushed downstream, and provides resistance to torque while the wheel turns. Third, the screen is transferred from the crane to its position on the drawbridge. Fourth, the wheel assembly (wheel, pontoons, speed increaser and generator) are lowered into the water and power generation is resumed.

### Special Cases

I. Mechanical Power

If the invention is to be used for mechanical power, the system would generate electricity as above, which would be used to power an electric pump to pump river water up to a holding tank. This water would then be used to power a turbine or traditional overshot wheel in a flume that would feed the water back to the river. The rotation of the turbine or overshot wheel would turn a shaft that could be used for direct mechanical power.

II. Multiple Wheels

It would be possible in some locations to place a number of wheels in series downstream of a single drawbridge. Each would require its own crane, especially where the flow of the river or stream is unregulated. Alternately, many wheels could be deployed on the same axis on very wide rivers, necessitating a wide bridge and crane.

III. Use of Fixed Bridges

The protective screen could be attached to a fixed bridge, with the crane and wheel(s) positioned downstream.

IV. Funnel

A funnel may be added, attached to the bridge, with solid walls leading to the wheel work area. In low water conditions the funnel will cause an acceleration of water from the bridge to the wheel and also aid in keeping fish and other creatures out of the wheel's path.

V. Tidal Areas

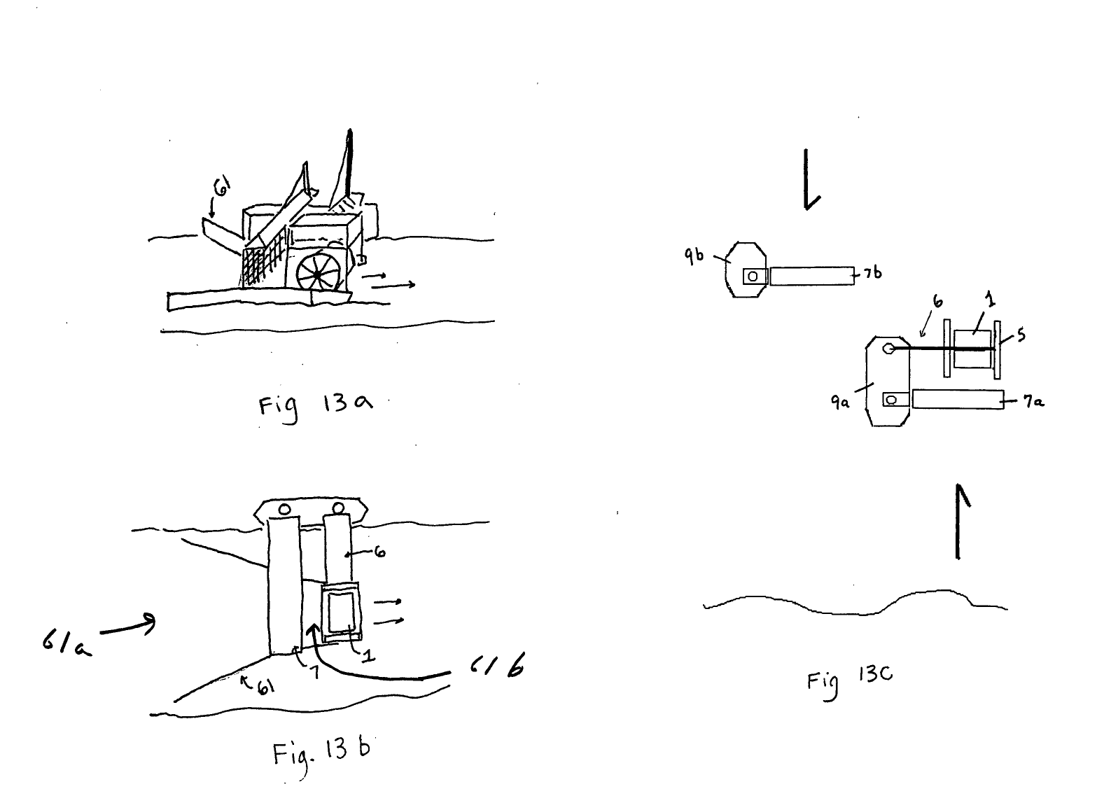

In tidal areas where water flows in alternating directions, the rotation of the invention will allow for power generation from the water flow in both directions. A second anchor to accommodate a second drawbridge is required. The two bridges could both be anchored perpendicular to the tidal flows and hold protective screens in order to shield the wheel from debris in either of two work locations. The anchors would be parallel to each other and parallel to the direction of the water's movement. The ends of the bridges point in the same direction. One bridge, used while the water is flowing away from land, would share an anchor with the crane. This anchor is located in the center of the “work area” and the bridge is mounted inland from the crane. The second bridge would be located further from land, and anchored on the perimeter of the work area, “upstream” when the tide is flowing towards land. The use of a second anchor allows the second bridge to be raised and allow the crane, wheel and pontoons to pass under it as the crane rotates 180 degrees with the shift of the tide. In areas subject to ocean storms, a protective shell that covers the wheel and pontoon assembly may be required. (See FIG. 13.)

### Best Mode

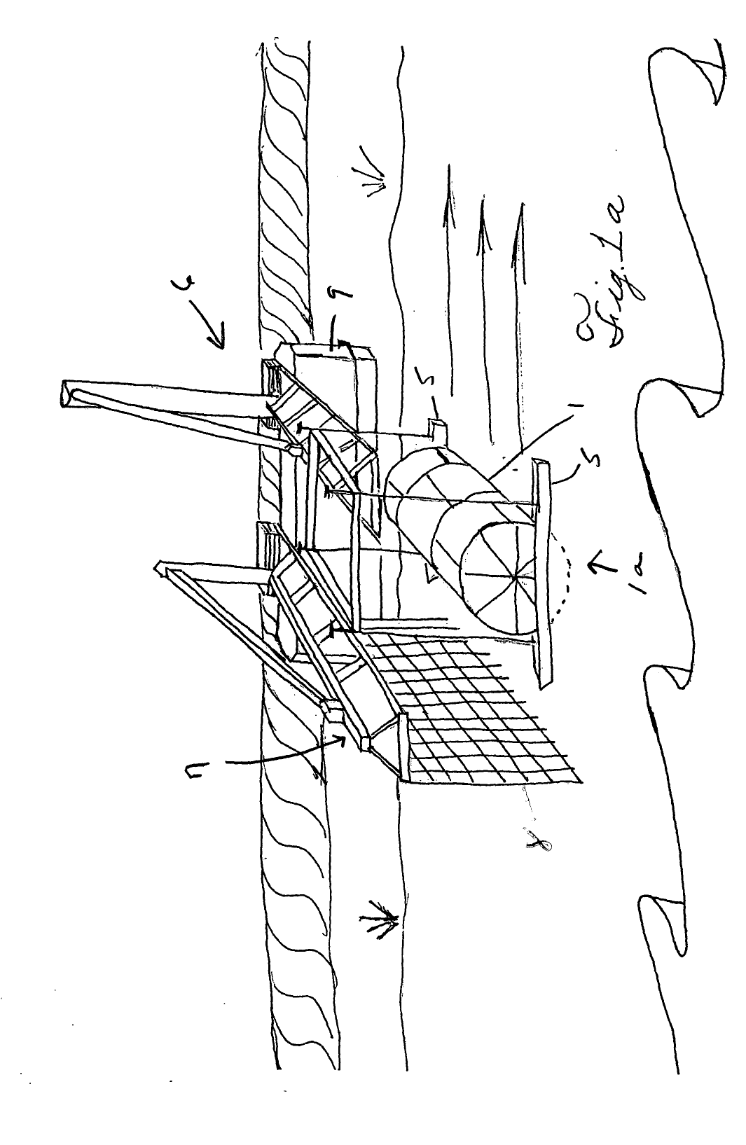

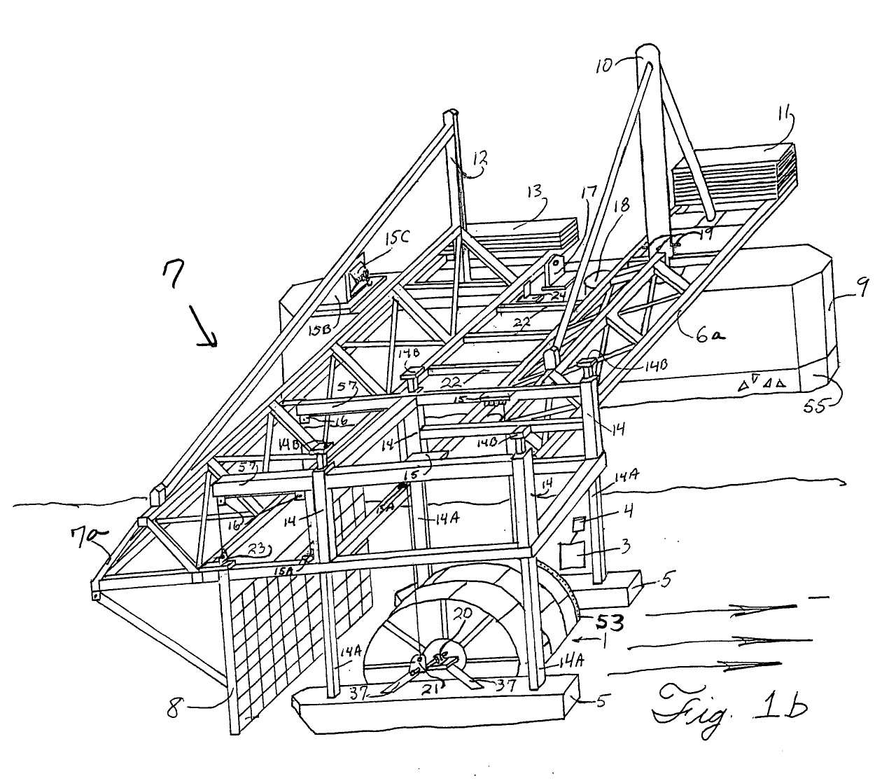

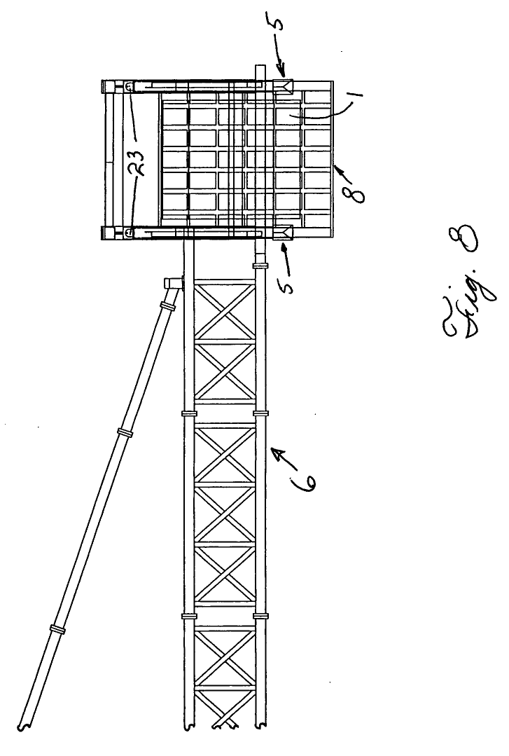

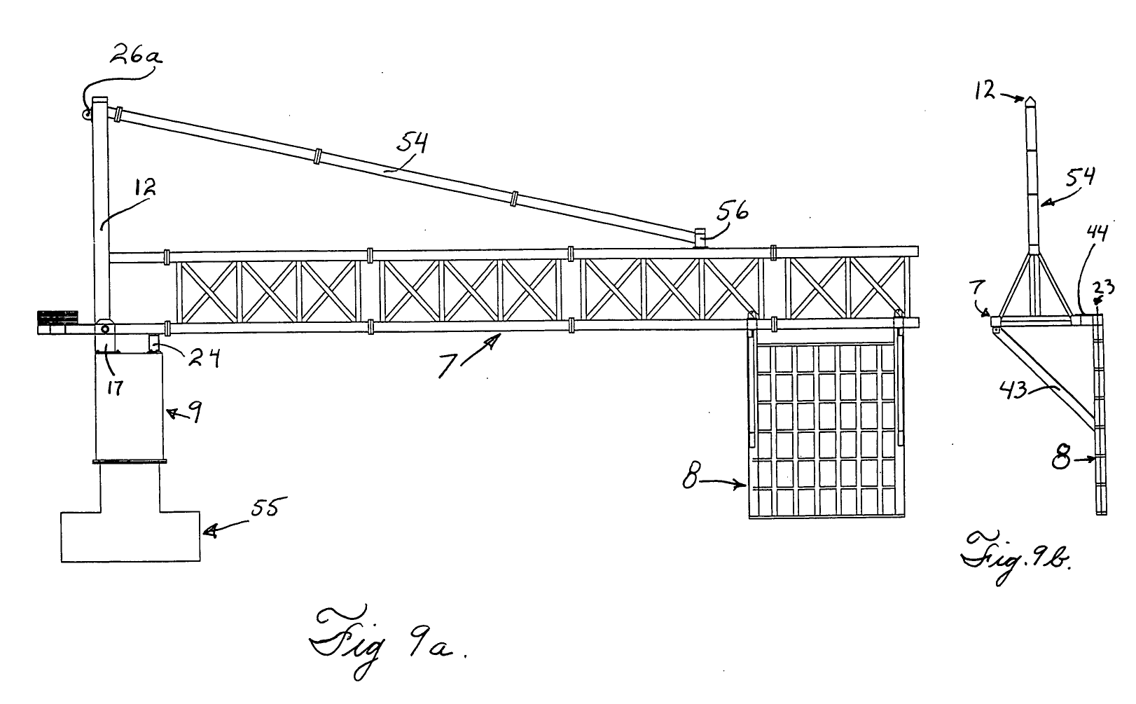

FIGS. 1a & 1b show a typical small installation of the hydro-power generating system for use on a stream of moving water. A large floating cylindrical aluminum wheel assembly 1a including water wheel 1 is shown with a three-inch wide stainless rim 53 with holes on the anchor side (alternately, a rim of gear sprockets could be used). Pontoons 5 support the wheel's axel with pillow block bearings 20, while allowing the wheel to rise and fall with the water. The jib crane 6, which includes a first elongated rigid structure 6a, is designed to ensure that the pontoons and water wheel rise and fall with the change of the water level, but do not fall below the minimum working level for the wheel. Four hollow vertical steel guides 14 on the jib crane guide an aluminum leg 14a attached to each of the up and downstream ends of each pontoon. Each leg 14a has a stop 14b at the top to prevent the wheel/pontoon assembly from dropping below the minimum safe working level. The guides and legs also allow the wheel/pontoon assembly to be raised. The crane is fitted with two 8,000 lb 12 volt-DC winches 15 to pick up the wheel/pontoon assembly with the lifting lugs 21 on the wheel axel. There are also two 8,000 pound 12 volt-DC winches 15a to pick up the protective screen 8 by the lifting lugs 23 on the screen. In order to pick up the screen, the crane is fitted with horizontal members 57 with four sheaves 16 for the wire rope of the winches (stiff legs 45 not shown, see FIG. 10a). An additional 12 volt-DC winch, 12,000 lb 15c, located on the anchor deck, is used to rotate the crane to shore carrying the wheel, pontoons and screen. On large installations this winch may be replaced with a mechanical drive mechanism. The drawbridge 7, including a second elongated rigid structure 7a has stabilizing cross-links 22 to the jib crane 6 when it is deployed in the at-work position, generating electricity. The bridge also provides support for the protective screen 8. Both bridge and crane each have a counterweight 11 and 13 respectively. The crane and the drawbridge are anchored by an anchor assembly in the form of a large concrete footer (55) with attached steel service hull 9. Additional features shown include: Entry way 18 into the interior of the service hull 9; three pegs 19 on crane mast used to rotate the crane 6; pillow block bearing 20, two required, one attached to each pontoon support 37 for the wheel axel; speed increaser 3 driven by a sprocket tipped shaft 50 that engages with the holes in the stainless steel rim 53 of the wheel, and generator(s) or alternator(s) 4. Drawing does not show catwalks and ladders.

FIG. 2 is a top view of a typical, small to large installation deployed to generate electricity with the wheel 1 and pontoons 5 protected by the screen 8. View of service hull 9 (on top of concrete anchor) with parallel position of jib crane 6 and bridge 7 shows stabilizing cross links 22, and bosses and pins which allow release of the cross links, which stay attached to the bridge 7 when released. Also on the anchor is a locking pin 27 to secure the jib crane in the at-work position, parallel to the bridge. The pin is removed in order to swing the crane. The two draw bridge hinges 17 are also attached to the anchor, as are two stops 24 on which the bridge rests when fully lowered. A second, smaller anchor 25 is located inland from the large anchor footing. On it is secured a 12,000 lb 12 volt-DC electric winch 15a that is used to pick up the drawbridge as well as lower it. A snatch block 26 effectively doubles the lifting capacity of the winch. On large installations, larger winches would be employed, or a mechanical drive mechanism (motor).

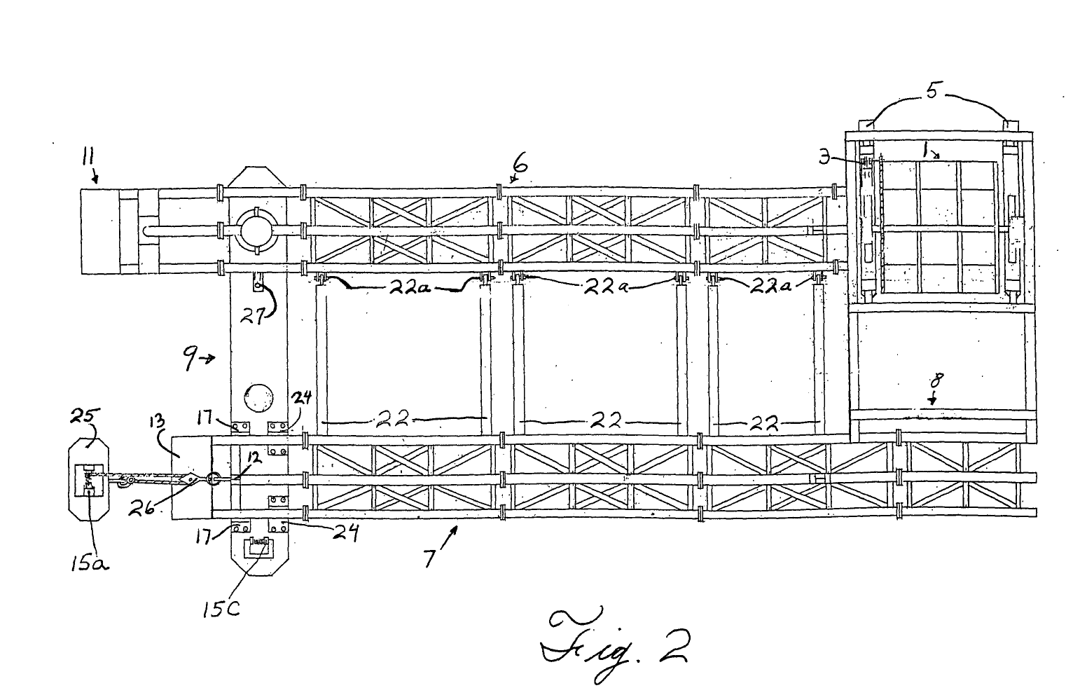

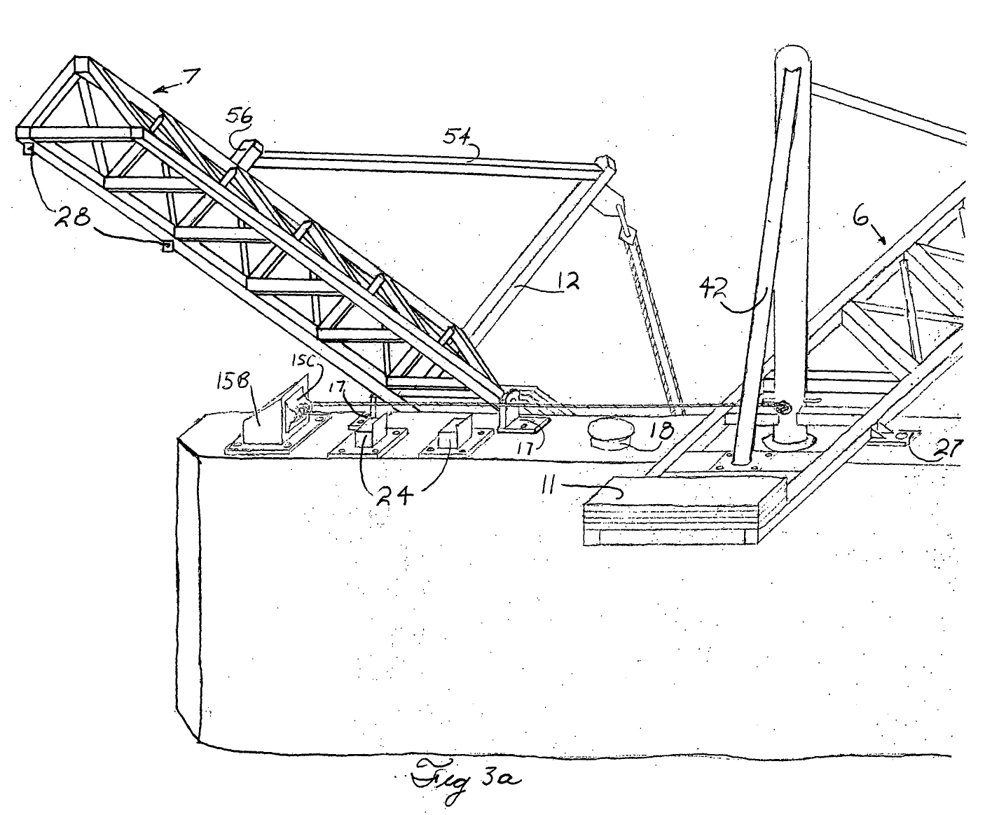

FIG. 3a shows the jib crane 6 carrying the wheel rotated fully to shore, and the drawbridge 7 raised as might be the case for service and/or flood (not generating electricity). Stiff leg 42 and counterweight 11 are shown, as is the entry 18 to the service hull 9. The bosses 28 help hold the protective screen in place, as are the drawbridge stops 24 and hinges 17. The drawbridge mast 12, jib 54 and jib mast 56 are shown. The jib crane-locking pin 27 is now secured to hold the crane in place while rotated away from the river.

FIG. 3b shows the anchor 55, service hull 9 and drawbridge 7 of FIG. 3a, shown in the raised position, (winch and its footing and tackle not shown) with lifting lug 26a. During a flood, the bridge is lifted to avoid providing an abstruction to objects in the floodwaters.

FIG. 4 shows the crane end of anchor/service hull 9, showing the position of one (of eight) interior structural vertical member 34 with rollers 33, as well as the position of the seven other rollers 33 (structural members 34 not shown), around the crane's mast 10, which are part of the rotational mechanism. The crane-locking (stabilizing) pin 27 is shown.

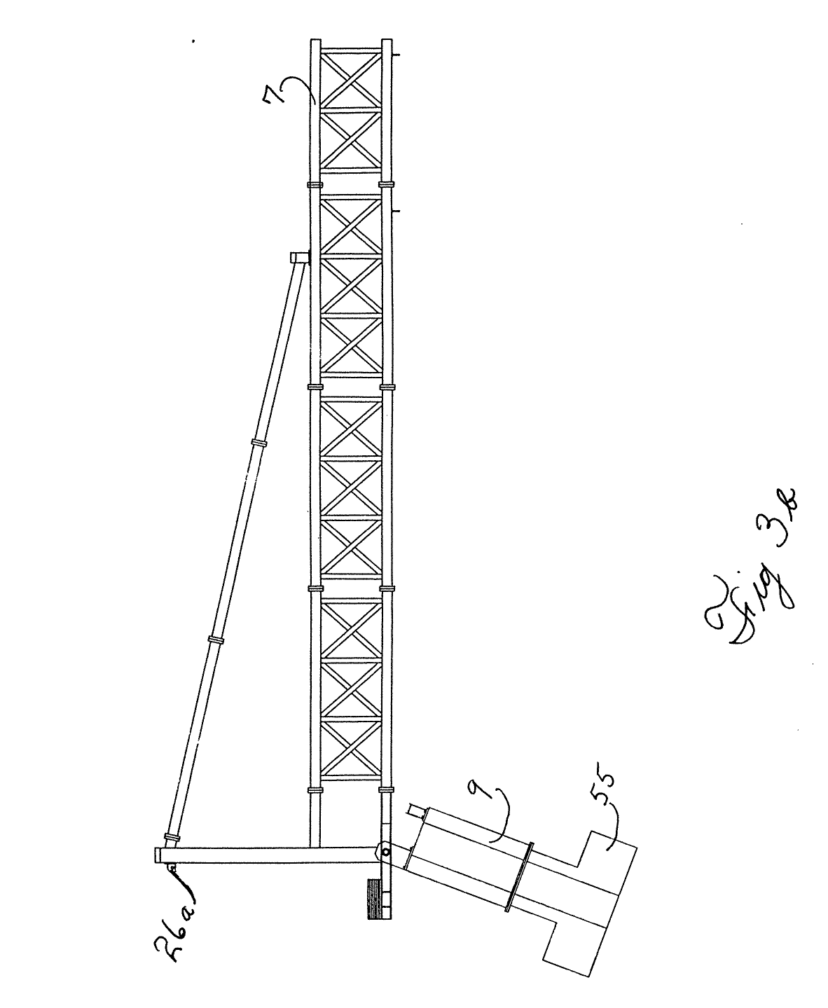

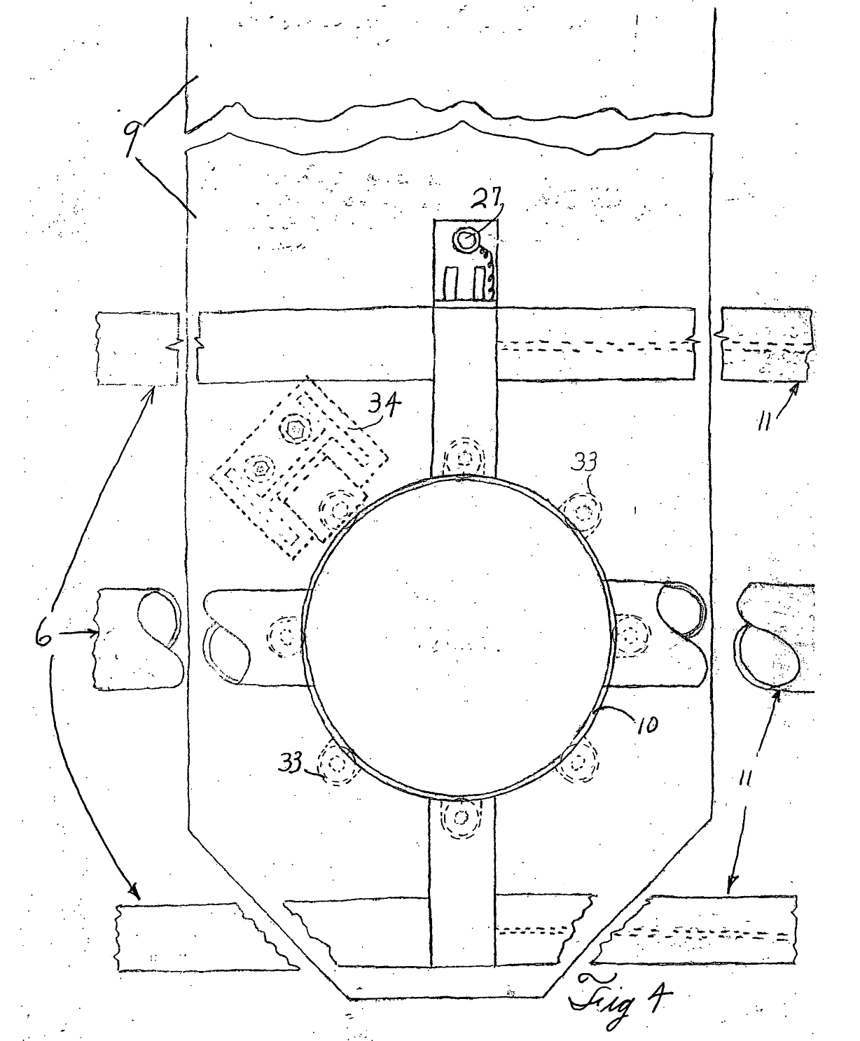

FIG. 5 shows the crane end of service hull 9 and anchor 55, with cut away views of interior structural steel 34 and also the mast cylinder 10 itself. Two of three pegs 19 for rotating the crane are shown, just above the attachment points for the arm of the crane and the counterweight. Below these attachments is shown a cone 29 to shield the anchor interior from rain. The cut away of the mast itself shows structural steel gussets 30 and 31, of which there are twenty-four and two horizontal plates 32 and 36 that reinforce the mast in the regions where the vertical turning rollers 33 operate on the exterior of the mast column. The sixteen vertical rollers 33, eight above and eight below, rotate on pins 33A, which are held in place by roller guides 33B. Below the bottom plate of the mast 36 twelve horizontal turning rollers 35 are arranged on the base 40 in a radial pattern (see FIG. 6). The anchor flange 54 secures the service hull 9 to steel embedded in the concrete portion of the anchor 55.

FIGS. 6a & 6b show the base 40 with twelve horizontal base rollers 38 arranged in a radial pattern, that turn on pins 39 and allow the mast 10 to rotate. Rollers are held in place by roller guides 38A attached to roller bases 38B that are bolted to the base 40. Note, several rollers are omitted in the side view (FIG. 6b). Any other turning mechanism may also be used (for example, bearings).

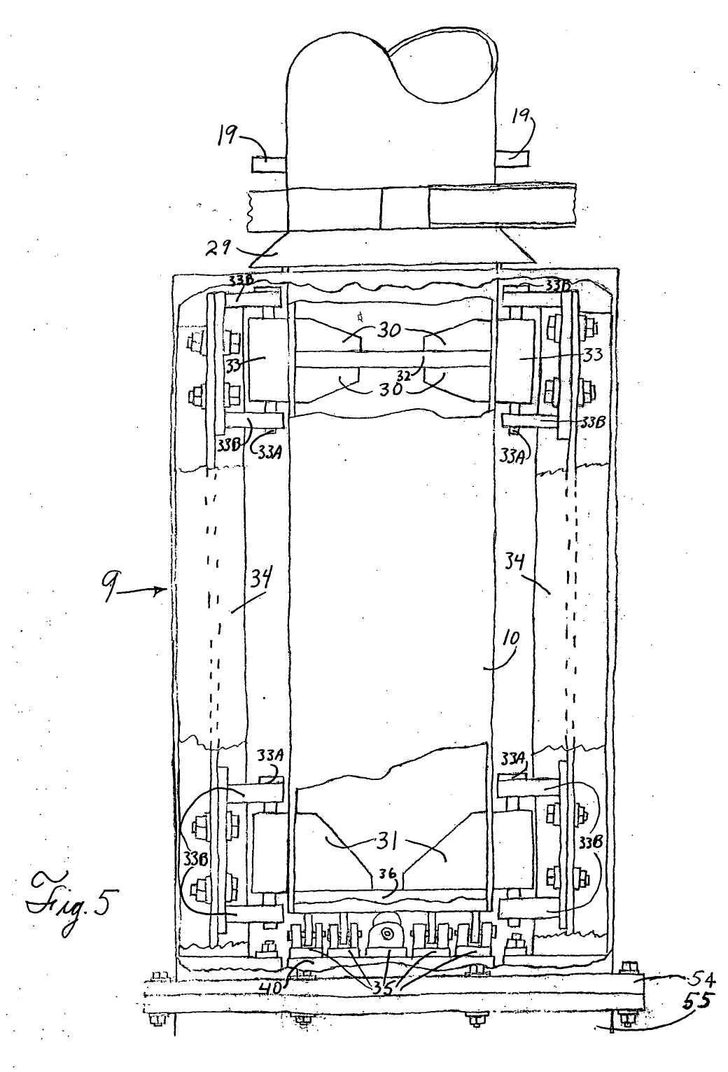

FIG. 7 shows the crane 6, anchor 55/service hull 9, wheel 1, and screen 8. Jib mast 41A is shown on upper portion of crane arm and jib 41 extending to crane mast. Counterweight stiff leg 42 is attached to counterweight arm proximal to the counterweight 11. Screen 8 and wheel 1 and pontoons 5 are shown in the at-work position. Lifting lugs 23 are shown on top of the screen 8.

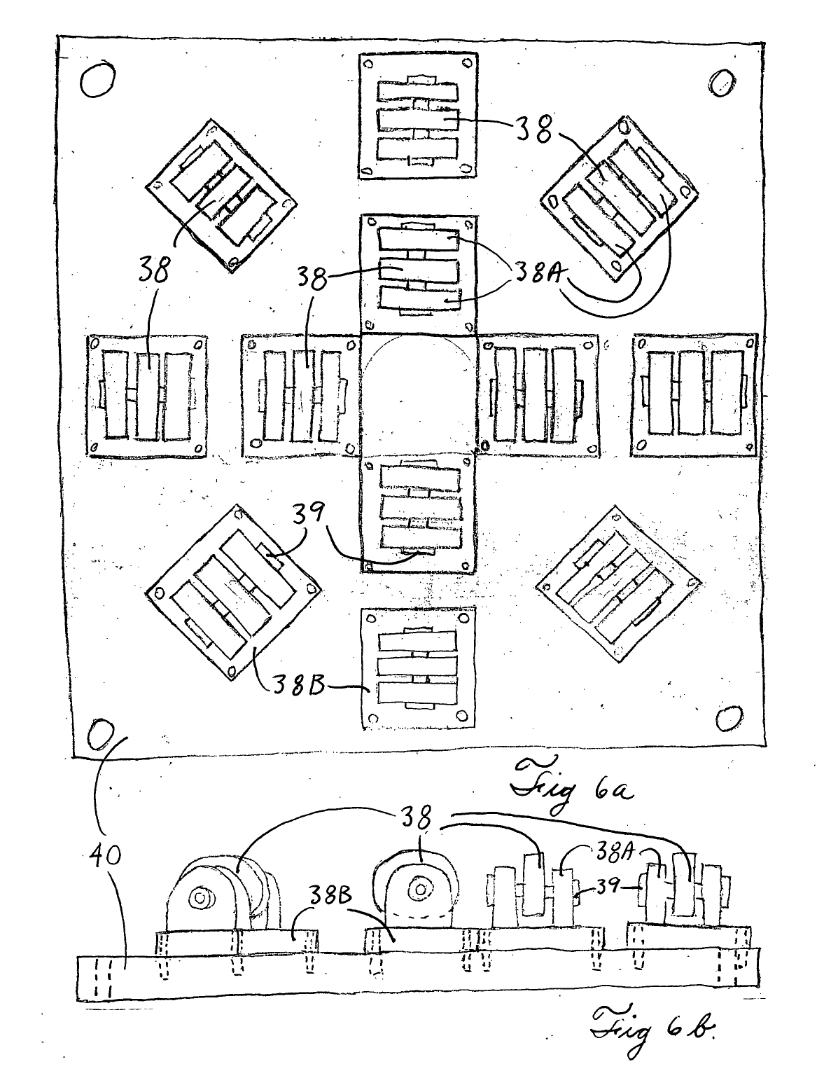

FIG. 8 shows the end of the crane arm 6, with wheel 1/pontoon assembly 5 and screen 8, shown raised. Screen lifting lugs 23 are shown, and winches described in FIG. 1 are omitted. Raising the wheel and screen are required for rotation of the crane.

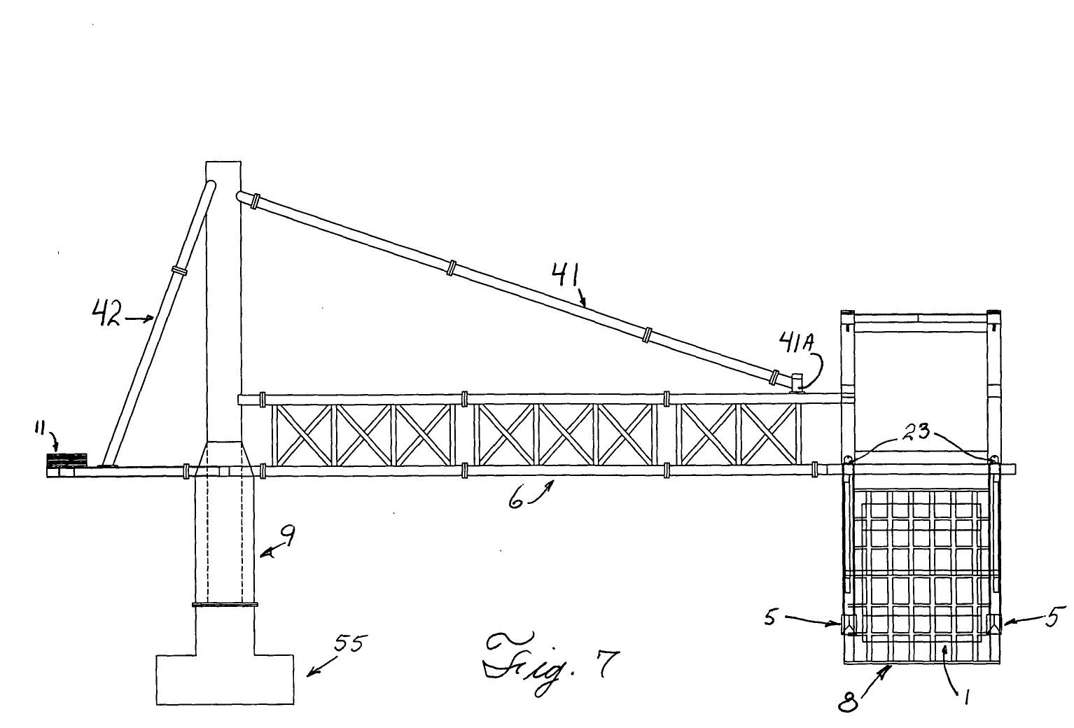

FIGS. 9a & 9b show the drawbridge 7, anchor 55, service hull 9, screen 8; end view of bridge span and screen. Drawbridge mast 12 is centered with the drawbridge jib 54 extending to the drawbridge jib mast 56 on the top of the drawbridge span. Drawbridge stops 24, two required, are located on the service hull deck. The hinges 17, landward of the stops 24, are atop structural steel in the service hull 9. Screen 8 is shown in the at-work position. FIG. 9b, end view, shows that the screen is supported by the bridge span 7, resting on the screen slide plate 44, as well as two angle braces 43. Screen lifting lugs 23 are also visible.

FIGS. 10a, 10b & 10c show the crane 6, wheel 1, pontoons 5, screen 8 and lifting structures. FIG. 10a shows the crane, wheel and screen in the at-work position. The screen slide plate 44 that rests on the drawbridge is detailed here, as well as stiff legs 45 that provide stability for the horizontal members 57 used to lift the screen. FIG. 10b shows the wheel/pontoon assembly raised, with the aluminum legs 14a with stops 14b emerging from the vertical guides 14. The screen is shown still lowered. The screen is required to be in the lowered position until after the wheel/pontoon assembly is safely out of the water. FIG. 10c shows the wheel/pontoon assembly and the screen in the fully raised position, ready for the rotation of the crane. Support angle 43 shown in FIG. 9b, which remains attached to the screen, is not shown, nor are the winches and sheaves used to accomplish the lifting in all views.

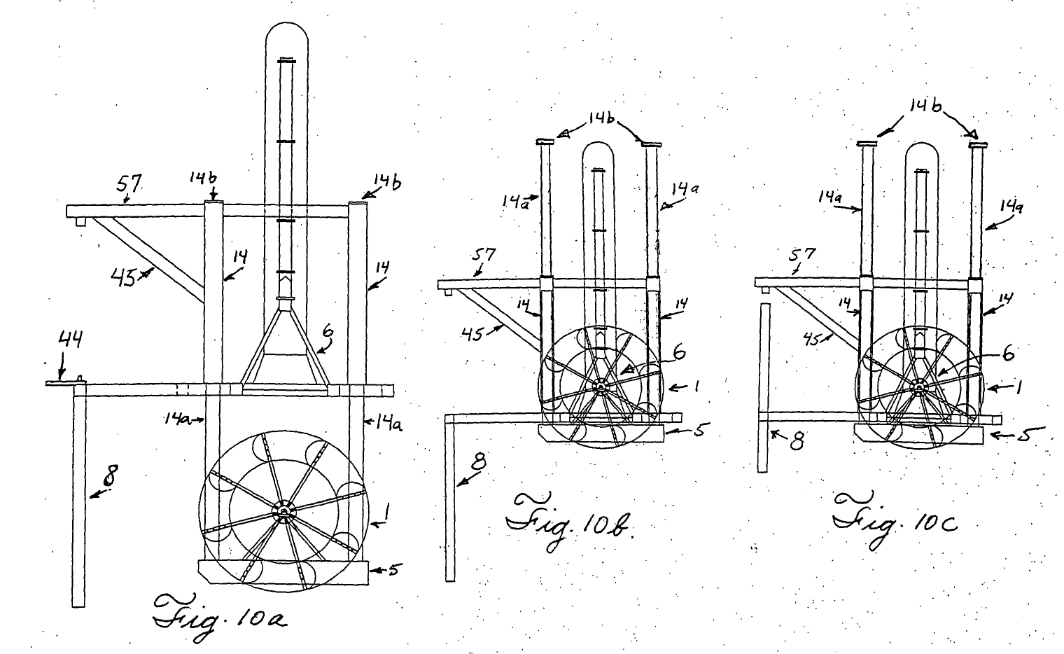

FIG. 11a shows the end view of each of three sections of the waterwheel 1. The wheel is divided into three sections that are rotated 15 degrees in relation to each other with respect to the position of the spokes 47 and floats 48. In each section, the spokes are attached to the central wheel plate 49, a total of four required. The wheel plates are attached to the wheel axel 46 shown in FIG. 11b. The 15-degree rotation of the wheel sections, also shown in FIG. 11b, enhances smooth rotation of the wheel and therefore enhances the engagement of the stainless steel ring gear 53 with the sprocket gear (not shown). Wheels may be made wider by adding sections. Other arrangements of spokes and floats may also be used.

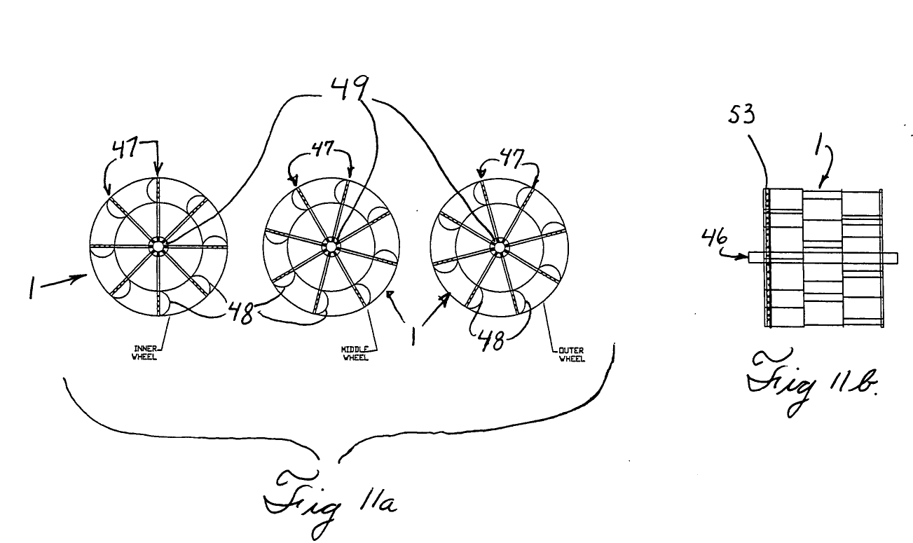

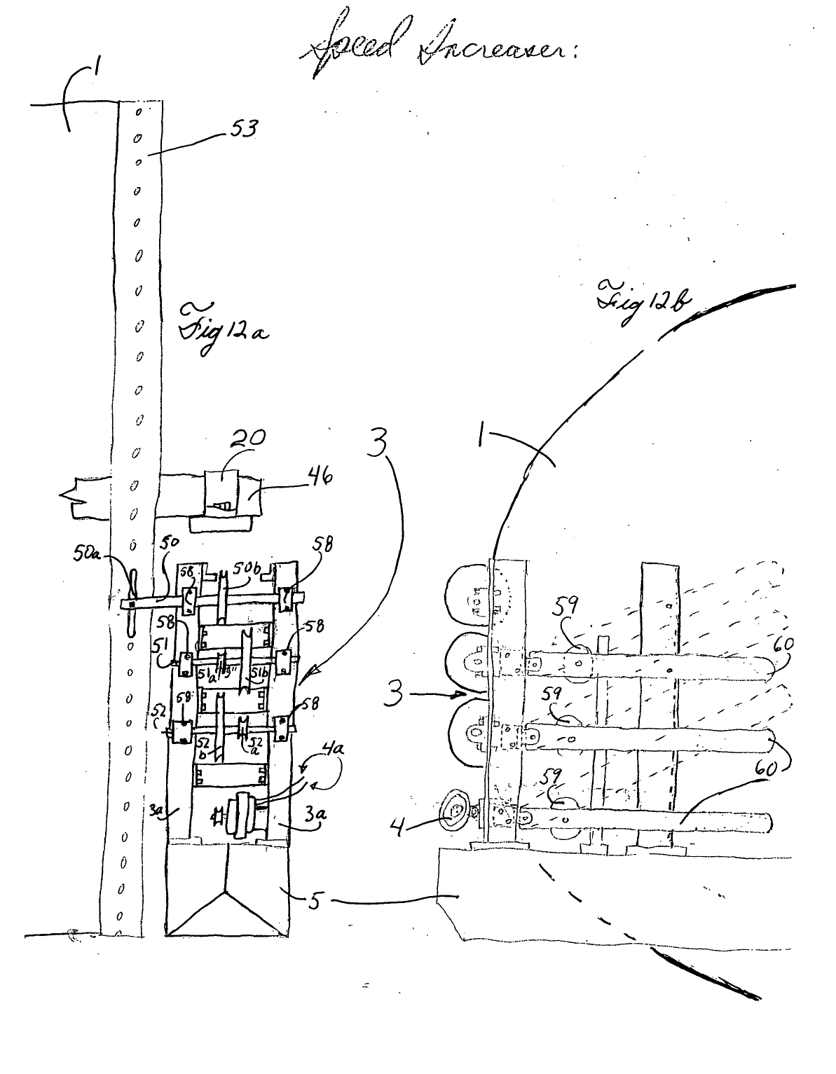

FIGS. 12a & 12b show details of the speed increaser 3. The function of the speed increaser is to step up the revolutions per minute from the large wheel in the water to the rate needed to operate the generator(s) 4 or alternator(s). The speed increaser 3 is located on the landward pontoon 5 with small sprocket gear 50a engaged with the stainless ring gear 53 on the landward edge of the wheel 1 (not shown). The sprocket gear shaft (50) has a large pulley 50b, which carries a belt that links to a very small pulley 51 a on a second shaft 51. The second shaft 51 also has a large pulley 51 b that is linked to a very small pulley 52a on a third shaft 52. This pattern is repeated one more time on the third shaft 52 where the large pulley 52b and belt link to the generator(s) 4 or alternator(s) for the production of electricity, transmitted by wires 4a. Each shaft rides on pillow block bearings 58, two per shaft attached to the speed increaser supports 3a. This view also shows the pillow block bearing 20 for the wheel and the wheel axel 46, but lifting lug 21 is not shown. FIG. 12b shows idler pulleys 59) and handles 60 needed to tighten the speed increaser belts. The release position of each idler pulley handle is shown in phantom lines. As stated above, in large installations the speed increaser may be replaced by a gearbox that performs the same function. Such an assembly should be lubricated with food-grade oils.

FIGS. 13a & 13b depict the use of a funnel 61 attached to the drawbridge 7 which extends under the bridge and crane 6 and embraces the wheel 1. The funnel includes wide open end 61a and narrow open end 61b adjacent wheel assembly 1a.

FIG. 13c is an overview of a tidal installation. The wheel 1 floating on pontoons 5 secured by the crane 6 is shown in the “at work” position during the outflow of water away from the shore. The crane is located on an anchor 9a with the drawbridge 7a that is on the landside of the same anchor. The rotation of the crane away from shore would bring the wheel under the second drawbridge 7b to the “at work” position when the tide is coming in. Drawbridge 7b is anchored with a second footing 9b.

From the foregoing description of the preferred embodiments of the invention, it will be apparent that many modifications may be made therein. It will be understood, however, that the embodiments of the invention are an exemplification of the invention only in that the invention is not limited thereto. It is to be understood, therefore, that it is intended that the appended claims cover all such modifications as fall within the true spirit and scope of the invention.

1. A hydro-power generating system comprising:
a wheel assembly including at least one rotatable wheel; said rotatable wheel adapted to interface with moving water; said rotatable wheel rotating when contacted by moving water, thereby generating power;
a first elongated rigid structure, at least a portion of which being situated above said rotatable wheel; said rigid structure being secured so that the moving water will not cause the rigid structure to move substantially;
said wheel assembly including at least one floatation member wherein said rotatable wheel will only be partially submerged in the moving water; said wheel assembly connected to said first elongated rigid structure so that the wheel assembly is held in place in the moving water.

2. A hydro-power generating system as set forth in claim 1, wherein said wheel assembly is slideably connected to said first elongated rigid structure so that rotatable wheel may move vertically as the level of the moving water changes.

3. A hydro-power generating system as set forth in claim 2, wherein said floatation member includes at least one pontoon; said pontoon connected to said rotatable wheel.

4. A hydro-power generating system as set forth in claim 3, wherein said at least one pontoon includes first and second pontoons; said first pontoon located on one side of said rotatable wheel and said second pontoon located on the other side of said rotatable wheel; at least one rod extending upwardly from each of said pontoons; first and second hollow sleeves extending downwardly from said first elongated rigid structure; said rod from said first pontoon slidably received in said first sleeve and said rod from said second pontoon slidably received in said second sleeve.

5. A hydro-power generating system as set forth in claim 4, wherein the distal end of each rod has a cap, the diameter of which is greater than the diameter of the hollow portion of its corresponding sleeve, whereby the rotatable wheel will not be lowered beyond a predetermined level.

6. A hydro-power generating system as set forth in claim 1, wherein said first elongated rigid structure being raisable and rotatable, whereby the wheel assembly may be removed from the moving water.

7. A hydro-power generating system as set forth in claim 6, wherein said first elongated rigid structure forms a part of a crane; said crane further including a mast and a winch.

8. A hydro-power generating system as set forth in claim 1, further including a screen; said screen adapted to be located in close proximity to, but upstream from, said wheel assembly; said screen permitting water to readily pass there through and reducing the likelihood that debris will interfere with said rotatable wheel.

9. A hydro-power generating system as set forth in claim 8, further including a second elongated rigid member; said screen attached to said second elongated rigid member; said second elongated rigid member being secured so that said screen will be held in place in the moving water.

10. A hydro-power generating system as set forth in claim 1, further including a funnel assembly having a wide open end and a narrow open end; said narrow open end of said funnel assembly adjacent to said wheel assembly; said funnel assembly for increasing the speed of the moving water as the moving water contacts the rotatable wheel.

11. A hydro-power generating system as set forth in claim 1, further including a rotational speed increaser connected to said rotatable wheel.

12. A hydro-power generating system as set forth in claim 9 wherein said second elongated rigid member is removably attached to said first elongated rigid member, thereby further stabilizing said first elongated rigid member.

13. A hydro-power generating system as set forth in claim 12 wherein said funnel is attached to said second elongated rigid member.

14. A hydro-power generating system as set forth in claim 1 wherein said rotatable wheel includes at least first and second cylindrical sections; each of said sections including a plurality of paddles for engagement with the moving water; the paddles of said first section being offset from the paddles of said second section.

15. A hydro-power generating system as set forth in claim 1, further including an anchor assembly; said first elongated rigid structure being connected to said anchor assembly.

16. A hydro-power generating system as set forth in claim 15 wherein said anchor assembly is in the form of a concrete pillar.

17. A hydro-power generating system comprising:
a wheel assembly including at least one rotatable wheel; said rotatable wheel adapted to interface with moving water; said rotatable wheel rotating when contacted by moving water, thus generating power;
a funnel assembly having a wide open end and a narrow open end; said narrow open end of said funnel assembly adjacent to said wheel assembly; said funnel assembly for increasing the speed of the moving water as the moving water contacts the rotatable wheel.

18. A hydro-power generating system comprising:
a wheel assembly including at least one rotatable wheel; said rotatable wheel adapted to interface with moving water; said rotatable wheel rotating when contacted by moving water, thus generating power;
a screen; said screen located in close proximity to and upstream from said wheel assembly; said screen permits water to readily pass there through and reducing the likelihood that debris will interfere with said rotatable wheel.

19. A hydro-power generating system as set forth in claim 18, further including an elongated rigid structure; said screen attached to said elongated rigid structure; said elongated rigid structure being secured so that the moving water will not cause said elongated rigid structure and said screen to move substantially.
